(19) United States
(12) Patent Application Publication
(10) Pub. No.: US 2026/0021480 A1
(43) Pub. Date: Jan. 22, 2026

(54) PRODUCTION METHOD OF POROUS MATERIALS

(71) Applicant: National Taiwan University of Science and Technology, Taipei (TW)

(72) Inventors: WEI-HUNG CHIANG, Taipei (TW); CHENG-YOU HUANG, Taipei (TW)

(21) Appl. No.: 18/989,101

(22) Filed: Dec. 20, 2024

Related U.S. Application Data
(60) Provisional application No. 63/672,580, filed on Jul. 17, 2024.

(51) Int. Cl. B01J 37/34; B01J 20/22; B01J 20/30; B01J 31/16; B01J 35/39; B01J 35/60; B01J 37/02; B01J 37/06

(52) U.S. Cl. CPC B01J 37/349; B01J 20/226; B01J 20/3064; B01J 20/3071; B01J 31/1691; B01J 35/39; B01J 35/60; B01J 37/0236; B01J 37/06; B01J 37/343

(57) ABSTRACT

The present invention is related to a production method of porous materials comprising steps of: providing a micro-plasma system, which includes an anode, a cathode, and a reaction solution. The said anode is at least partially immersed in the reaction solution, while the cathode is a tube with its opening positioned near and above the reaction solution with a gas introducing to the opening. After applying a current to the micro-plasma system, a micro-plasma reaction occurs, resulting in the formation of a porous material in the reaction solution. The aforementioned reaction solution contains an amine precursor, an aldehyde precursor, and an electrolyte, and especially does not include any toxic or volatile organic solvents. The present invention presents a novel method for producing porous materials with simple and rapid steps without the need for volatile or toxic organic solvents, making the process more environmental friendly, cost-effective and high yielding rate.

### FIELD OF INVENTION

The present invention is related to a method for producing porous materials, particularly to a method for producing porous materials using a micro-plasma process.

The present invention has been developed primarily to be a porous material including such as Covalent Organic Frameworks (COFs) and Metal-Organic Frameworks (MOFs) for describing hereinafter with references and multiple embodiments to this application. However, it will be appreciated that the present invention is not limited to this particular types of material, method, field of use or effect.

### BACKGROUND OF THE INVENTION

Porous materials, such as Covalent Organic Frameworks (COFs) and Metal-Organic Frameworks (MOFs), exhibit numerous advantages and applications in scientific and industrial fields. COFs possess highly tunable porous structures, providing excellent gas adsorption and storage properties. By modifying organic groups and connecting units of such porous materials, the pore size and chemical functionality of COFs can be precisely controlled. Furthermore, COFs demonstrate outstanding chemical stability, maintaining structural integrity under acidic, alkaline, and organic solvent environment or conditions. Composed mainly of elements such as carbon, hydrogen, nitrogen, and oxygen, COFs generally exhibit low density. These properties allow COFs being highly promising for applications in gas separation, catalysis, energy storage, and sensors applications.

Metal-Organic Frameworks (MOFs) on the other hand, presents extremely high specific surface areas, which enable exceptional performance in gas adsorption and storage. By selecting different metal ions and organic ligands, MOFs with various structures and properties can be synthesized. Additionally, MOFs porosity and surface functionalities can be tailored through post-synthetic modifications or by adjusting synthesis conditions to meet specific application requirements. Certain MOFs exhibit excellent catalytic properties, making them suitable for catalytic reactions such as photocatalysis and electrocatalysis. Many MOFs can be regenerated through simple methods, enhancing their sustainability in practical applications.

COF and MOF materials both have highly crystalline structures, which make them efficient in molecular sieving and separation processes. Furthermore, these materials can be functionalized as needed to adapt to various application fields, including environmental protection, energy storage, and biomedicine. Their highly ordered structures and multifunctional abilities have made COF and MOF materials extremely important subjects of research in modern materials science, demonstrating immense application potential across multiple fields. COF, MOF, and any other similar porous materials exhibit highly efficient and selective photocatalytic properties, along with large surface areas that enable the rapid adsorption of environmental pollutants or targeted drugs for cancer therapy. These materials can therefore be applied as drug delivery carriers for cancer treatment, as well as for pollutant adsorption and photodegradation in environmental uses.

However, current synthesis methods for porous materials are relatively complicated, time and energy consuming, requiring organic solvents as crosslinking agents or reaction media, which are extremely harmful to the environment and costly as well. Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the disadvantages of conventional porous material synthesis methods, which are complex, time-consuming, and energy-intensive, and require organic solvents as crosslinking agents or reaction media, making them environmentally unfriendly and costly. The present invention provides a method for producing porous materials having the steps of:
Step 1: providing a micro-plasma system comprising: an anode; a cathode, and a reaction solution; wherein the anode is at least partially immersed in the reaction solution, the cathode is a tube with its opening positioned near and above the reaction solution, and a gas is introduced into the tube;
Step 2: applying a current to the micro-plasma system for a duration of 0.5 to 24 hours, thereby forming a porous material in the reaction solution.

The reaction solution in Step 1 comprises an amine precursor, an aldehyde precursor, and an electrolyte, and the reaction solution does not include any toxic or volatile organic solvents.

The concentration of the amine precursor ranges from 5 to 20 mM and includes 1,3,5-tris(4-aminophenyl)benzene.

The concentration of the aldehyde precursor ranges from 5 to 30 mM and includes one or a combination of benzene-1,3,5-tricarbaldehyde, terephthalaldehyde, and 4,4′-biphenyldicarboxaldehyde.

The concentration of the electrolyte ranges from 1 to 20 mM and includes acetic acid.

In accordance, the present invention has the following advantages:
1. The present invention proposes a method for producing porous materials with simple and rapid steps, without any usage of organic solvents, and offering high yield in low cost.
2. The porous materials produced by the present invention perform highly efficient and selective photocatalytic properties, along with a large surface area that enables the rapid adsorption of environmental pollutants or targeted drugs for cancer therapy. These materials can be applied as drug delivery carriers for cancer treatment and for the adsorption and photodegradation of environmental pollutants.
3. Porous materials, such as Covalent Organic Frameworks (COFs) and Metal-Organic Frameworks (MOFs), have a wide range of applications, including catalysis, gas storage and transportation, and supercapacitors. Moreover, synthesis of porous materials can be customized for specific applications by designing targeted structural motifs. However, most current synthesis methods rely on thermal solvent processes using organic solvents such as 1,3,5-trimethylbenzene and 1,4-dioxane, which require very harsh reaction conditions, including high temperatures, high pressures, and long reaction times.

The present invention demonstrates significant potential by developing a green and rapid synthesis method. Utilizing an atmospheric-pressure micro-plasma system, the process eliminates the need for organic solvents and accelerates the formation of porous materials under ambient pressure without requiring heating. This invention enables one-step surface functionalization and surface charge modification of porous materials, enhancing pollutant removal efficiency.

Under sunlight simulation tests, various embodiments of the present invention, as photocatalysts, achieved high or even complete removal of dyes such as Crystal Violet (CV) and Methylene Blue (MB), with bisphenol A removal efficiency reaching 99%. This method gives a promising, environmentally friendly, and sustainable approach for the production of porous materials in the fields.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 illustrates a schematic diagram of the micro-plasma system and apparatus in accordance to the present invention;

FIG. 2 illustrates an X-ray diffraction (XRD) patterns of Embodiments 1-3 of the present invention and Comparative sample 1;

FIG. 3 illustrates an UV/Vis diffuse reflectance spectroscopy (DRS) spectra of Embodiments 1-3 of the present invention and Comparative sample 1;

FIG. 4 illustrates a Fourier-transform infrared spectroscopy (FTIR) spectra of Embodiments 1-3 of the present invention and Comparative sample 1;

FIG. 5 illustrates a Raman spectra of Embodiments 1-3 of the present invention and Comparative sample 1;

FIGS. 6a-6c illustrate a direct bandgap Tauc plots and ultraviolet photoelectron spectroscopy (UPS) used for HOMO energy calculation of Embodiments 1-3 of the present invention and Comparative sample 1;

FIG. 7 illustrates some scanning electron microscope (SEM) images of Embodiments 1-3 of the present invention and Comparative sample 1;

FIG. 8 illustrates some thermogravimetric analysis (TGA) curves of Embodiments 1-3 of the present invention and Comparative sample 1;

FIG. 9 illustrates some X-ray diffraction (XRD) patterns of Embodiments 1-3 of the present invention and Comparative sample 1;

FIG. 10 demonstrates some adsorption performance of anionic and cationic pollutants by Embodiment 3 in accordance to the present invention;

FIG. 11 illustrates a zeta potential of Embodiments 1-3 of the present invention and Comparative sample 1;

FIG. 12 illustrates a photocatalytic performance of Embodiment 3 of the present invention for different organic dyes; and

FIG. 13 illustrates a photodegradation test of bisphenol A by Embodiments 1-3 of the present invention and Comparative sample 1.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

### <Method of Producing Porous Materials>

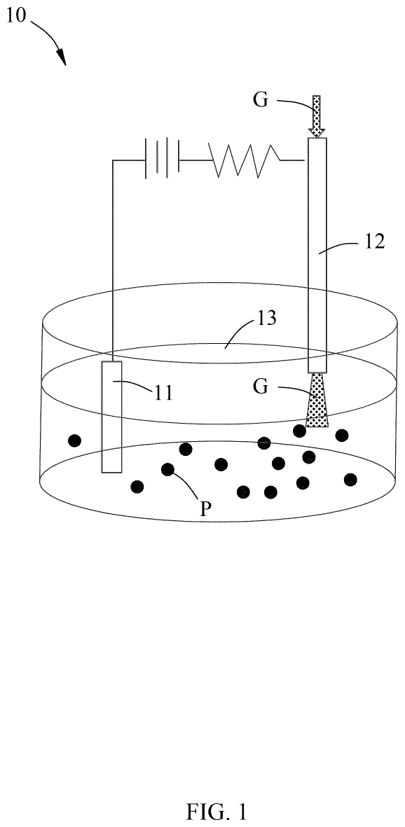

Referring to FIG. 1, a schematic diagram of the micro-plasma system 10 and apparatus used in the method for producing porous materials of the present invention is presented. The method comprises the following steps:
Step 1: Provide a micro-plasma system 10, which includes an anode 11, a cathode 12, and a reaction solution 13. The anode 11 is at least partially immersed in the reaction solution 13, while the cathode 12 is a metal tube with its opening positioned near and above the reaction solution 13. A gas G is applicably introduced into the tube.
Step 2: Apply a preset current and allow a chemical reaction to proceed for 0.5 to 24 hours, resulting in a formation of a porous material P within the reaction solution 13.

Preferably in this embodiment, the aforementioned porous material comprises Covalent Organic Framework (COF) and/or Metal-Organic Framework (MOF). The anode 11 is a platinum electrode, and the cathode 12 is preferably a stainless steel tube with an inner diameter ranging from 100 to 200 μm. In this preferred embodiment, the stainless steel tube of cathode 12 with a diameter of 178 μm is used. The gas G introduced into the tube comprises an inert gas, such as argon, with a flow rate ranging from 10 to 100 sccm; in this embodiment, a flow rate of 25 sccm is utilized. The current is preferably within the range of 0.1 mA to 100 mA.

The reaction solution 13 as mentioned in Step 1 contains an amine precursor, an aldehyde precursor, and an electrolyte. Preferably, the reaction solution 13 does not include any toxic or volatile organic solvents. Specifically, the reaction solution 13 excludes organic solvents such as 1,3,5-trimethylbenzene, 1,4-dioxane, o-dichlorobenzene, n-butanol, mesitylene, tetrahydropyran, N,N-dimethylacetamide, and ethanol, alone or in combination.

The concentration of the amine precursor in the reaction solution 13 ranges from 5 to 20 mM and includes 1,3,5-tris(4-aminophenyl)benzene (TAPB). The concentration of the aldehyde precursor ranges from 5 to 30 mM and includes one or a combination of the following: benzene-1,3,5-tricarbaldehyde (BTCA), terephthalaldehyde (TFA), or 4,4′-biphenyldicarboxaldehyde (BPDA). The concentration of the electrolyte ranges from 1 to 20 mM and includes acetic acid (CH₃COOH).
Step 3 (Optional)—Purification Step: The reaction solution 13 containing the porous material P is subjected to any appropriate purification, including centrifugation and ultrasonic washing, followed by drying to obtain the purified porous material P.

Preferably, in this embodiment, centrifugation and ultrasonic washing involve adding the reaction solution 13 containing the porous material P into ultrapure water, placing it into a centrifuge tube, and centrifuging to remove unreacted solution. Acetone is then added, and the powder is washed using an ultrasonic cleaner and centrifuged again to remove the washing acetone. Optionally, the aforementioned steps can be repeated to achieve higher or enhanced purification result.

Finally, ethanol is added to the centrifuge tube, and the porous material P powder is dispersed into an evaporating dish. The material is then dried in an oven until a dry powdered state is achieved.

### <Qualitative Testing>

Please refer to Table 1, which presents several preferred embodiments of the present invention and Comparative sample of porous materials synthesized using an existing ultrasonic process.

TABLE 1

| | | | | | | | | Comparative |
|---|---|---|---|---|---|---|---|---|
| | | Embodiment 1 | | Embodiment 2 | | Embodiment 3 | | sample 1 |
| | | TAPB_BPDA | | TAPB_TFA | | TAPB_BTCA | | Sonication |
| | | COFs | | COFs | | COFs | | COFs |
| Method | | Micro-plasma | | Micro-plasma | | Micro-plasma | | Ultrasonic |
| | | procedure | | procedure | | procedure | | procedure |
| Process | Anode | Platinum | | Platinum | | Platinum | | Ultrasonic |
| conditions | | electrode | | electrode | | electrode | | nano-disperser |
| | Cathode | Stainless steel | | Stainless steel | | Stainless steel | | with a 1 mm |
| | | tube (Inner | | tube (Inner | | tube (Inner | | micro-tip |
| | | diameter: | | diameter: | | diameter: | | probe, 40% |
| | | 178 μm) | | 178 μm) | | 178 μm) | | power output |
| | Current/ | 8 | mA | 8 | mA | 8 | mA | (max 700 W) |
| | Voltage | | | | | | | for 1 hour |
| | Gas/ | 25 | sccm | 25 | sccm | 25 | sccm | |

| | | | | |
|---|---|---|---|---|
| Flow rate | | | | |
| Reaction | TAPB(35.1 mg, | TAPB (35.1 mg, | TAPB (35.1 mg, | TAPB (35.1 mg, |
| solution | 0.1 mmol), | 0.1 mmol), | 0.1 mmol), | 0.1 mmol), |
| | BPDA(31.5 | TFA (20.1 mg, | BTCA (16.2 | BTCA (16.2 |
| | mg, 0.15 | 0.15 mmol), | mg, 0.1 mmol), | mg, 0.1 mmol), |
| | mmol) and | acetic acid | acetic acid | acetic acid |
| | acetic acid | aqueous | aqueous | aqueous |
| | aqueous | solution | solution | solution |
| | solution | (10 mL, 6M) | (10 mL, 6M) | (2 mL, 6M) |
| | (10 mL, 6M) | | | |

| | | | | |
|---|---|---|---|---|
| Porous material | COFs | COFs | COFs | COFs |

It is worthy noticed that the above embodiments are provided as exemplary Embodiments for better understanding of the present invention. Other embodiments not included in Table 1, such as MOFs, have also been proven to be effective.

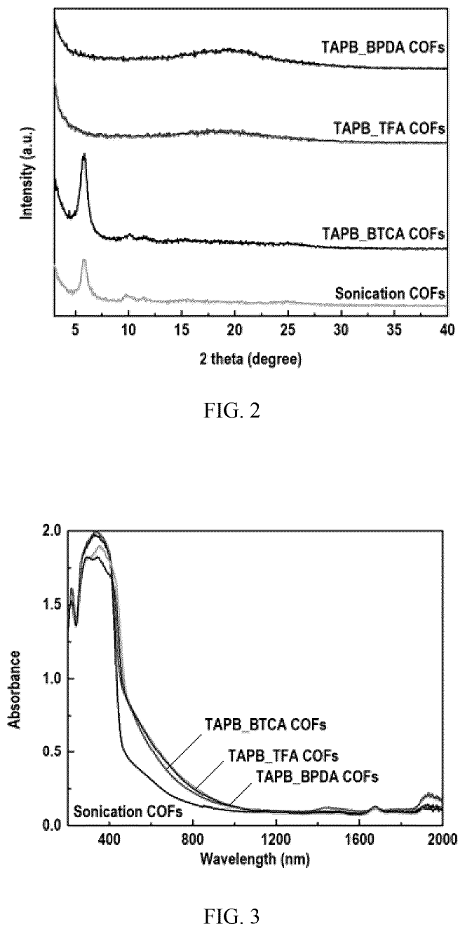

Please refer to FIG. 2, it shows some X-ray diffraction (XRD) patterns of Embodiments 1-3 of the present invention and Comparative sample 1. In FIG. 2, a diffraction peak corresponding to the (1,0,0) crystal plane of the embodiment 3 (TAPB_BTCA COFs) is observed at 2θ=5.8°, confirming the successful synthesis of highly crystalline COFs through the atmospheric micro-plasma treatment of the present invention. Additionally, the (1,1,0) crystal plane is identified at 2θ=10°.

Please refer to FIG. 3, some UV/Vis diffuse reflectance spectroscopy (DRS) spectra of Embodiments 1-3 of the present invention and Comparative sample 1 listed in Table 1 are presented. In FIG. 3, the embodiments of the present invention exhibit broad absorption in the UV-Visible light region. Compared to the Comparative sample, the embodiments of the present invention performs greater light absorption, enabling effective utilization of the majority of light emitted by any solar simulator used in the photocatalytic tests and enhancing light utilization efficiency.

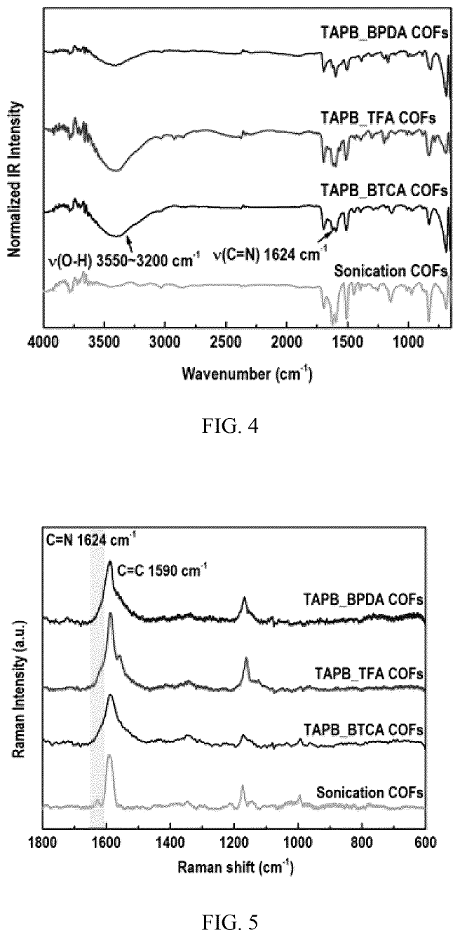

Please refer to FIG. 4, it shows a Fourier-transform infrared spectroscopy (FTIR) spectra of Embodiments 1-3 and Comparative sample 1 listed in Table 1. The FTIR spectra present a presence of functional groups such as hydroxyl groups and carbonyl groups in the chemical structures of porous material of the embodiments disclosed by the present invention. A distinct peak has observed at 1624 cm⁻¹ corresponds to the C═N bond, indicating the successful formation of imine linkages in the COFs synthesized of the present invention. The embodiment 3 (TAPB_BTCA COFs) contains various functional groups that can absorb different pollutants, showing great potential for pollutant removal applications.

Please refer to FIG. 5, Raman spectra of Embodiments 1-3 and Comparative sample 1 are presented. A sharp peak has observed in a wavelength ranging from 1580-1590 cm⁻¹ corresponds to the C═C bond vibrations, indicating the presence of a highly ordered conjugated framework and porous structure. Peaks in the range of 1620-1630 cm⁻¹ are attributed to the formation of imine linkages within the COFs.

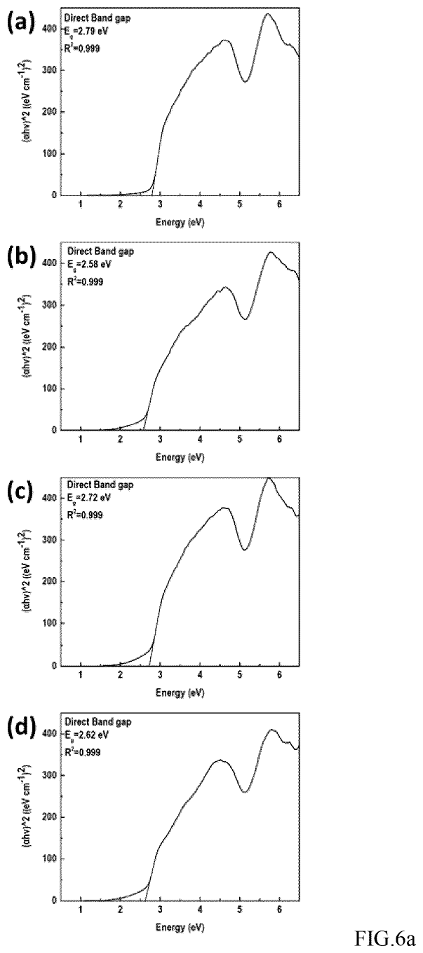

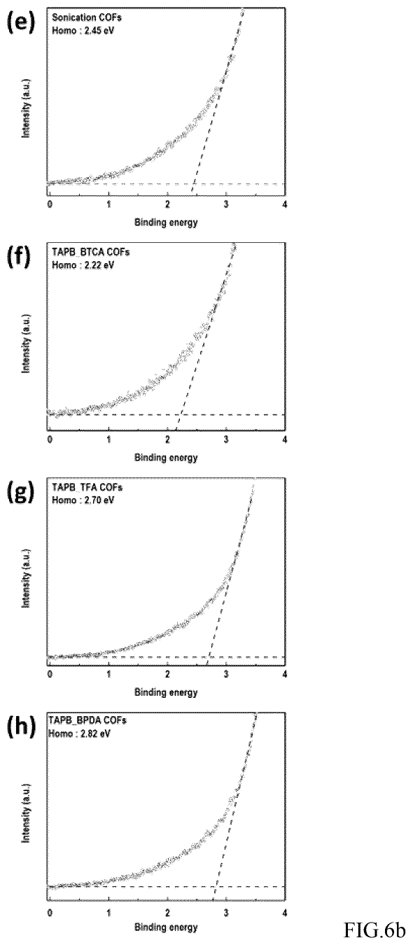

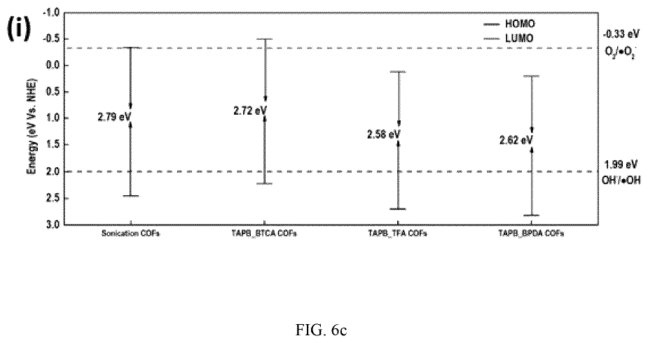

Please refer to FIGS. 6a-6c, some of the direct bandgap Tauc plots of Embodiments 1-3 and Comparative sample 1 listed in Table 1 are shown. In FIG. 6a, (a) represents Comparative sample 1, (b) represents Embodiment 3 of the present invention (TAPB_BTCA COF), (c) represents Embodiment 2 (TAPB_TFA COF), and (d) represents Embodiment 1 (TAPB_BPDA COF).

To determine the HOMO energy levels, certain ultraviolet photoelectron spectroscopy (UPS) results are shown in FIG. 6b wherein (e) represents Comparative sample 1, (f) represents Embodiment 3 (TAPB_BTCA COF), (g) represents Embodiment 2 (TAPB_TFA COF), and (h) represents Embodiment 1 (TAPB_BPDA COF). Combined with the bandgap energy results from FIG. 6a (a)-(d), the energy band structures in FIG. 6c (i) are established. From the UPS spectra (e) to (h), the HOMO positions of each COF can be confirmed. It is observed that Embodiment 3 of the present invention generates superoxide radicals to degrade bisphenol A (BPA), while Embodiment 1 generates hydroxyl radicals for BPA degradation.

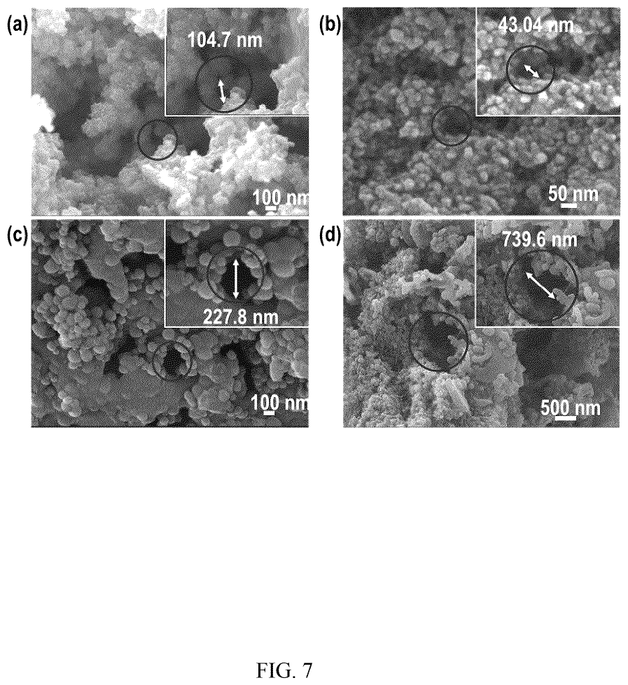

Please refer to FIG. 7, it shows the scanning electron microscope (SEM) images of Embodiments 1-3 and Comparative sample 1 listed in Table 1. In FIG. 7, (a) represents Comparative sample 1, (b) represents Embodiment 3 (TAPB_BTCA COF), (c) represents Embodiment 2 (TAPB_TFA COF), and (d) represents Embodiment 1 (TAPB_BPDA COF). The SEM images reveal that the surface and internal morphologies of the embodiments of the present invention exhibit a large number of porous structures.

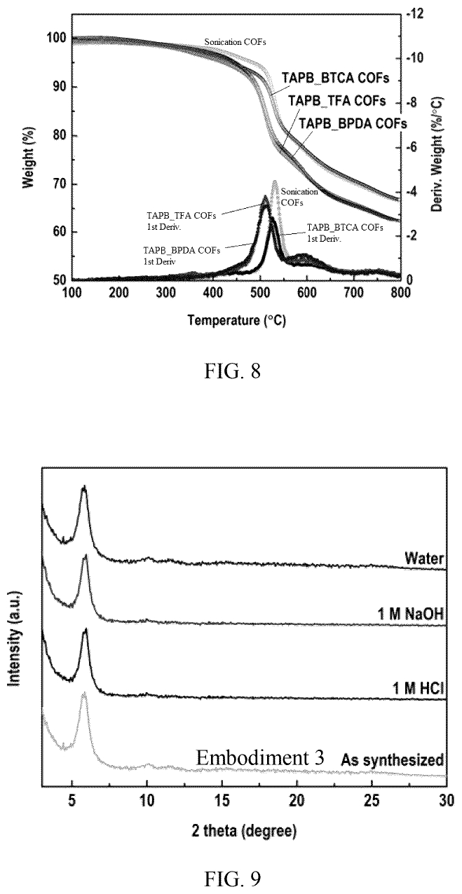

Please refer to FIG. 8, which shows the thermogravimetric analysis (TGA) results of Embodiments 1-3 and Comparative sample 1. The results indicate that the total mass loss for the embodiments of the present invention is only 33%, demonstrating excellent thermal stability, which is a critical characteristic for catalytic applications.

Please refer to FIG. 9, which shows the XRD patterns of Embodiment 3 after 24 hours of photocatalysis in different solutions. From FIG. 9, it is evident that Embodiment 3 of the present invention exhibits excellent chemical stability, withstanding strong acidic and alkaline environments without structural degradation. These results confirm that the embodiments of the present invention are highly suitable for applications in photocatalysis and pollutant removal.

Please refer to Table 2, which presents the yields of Embodiment 3 of the present invention and Comparative sample 1 listed in Table 1. The results demonstrate that the process provided by the present invention achieves a relatively higher yield.

TABLE 2

| | Theoretical weight | Actual weight | Yields |
|---|---|---|---|
| Samples | (mg) | (mg) | (%) |
| Comparative | 51.3 | 30.3 | 59.1 |
| Sample 1 | | | |
| Embodiment 3 | 51.3 | 37.5 | 73.1 |

<Validation Tests>

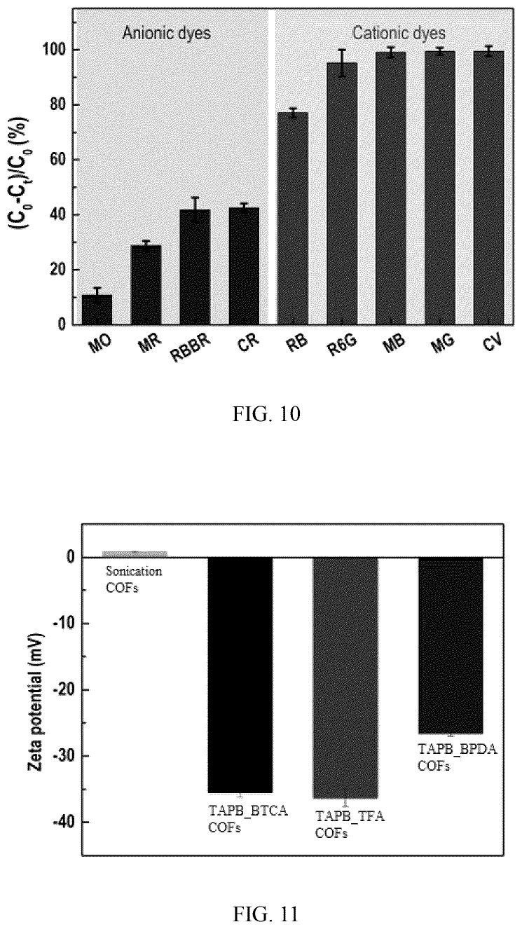

Please refer to FIG. 10, it illustrates the anionic and cationic pollutant adsorption performance of Embodiment 3 from Table 1. After 12 hours, the adsorption characteristics of Embodiment 3 for various organic pollutants are shown in FIG. 10. It has proven that the embodiments of the present invention exhibit excellent adsorption and removal capabilities for dyes.

Please refer to FIG. 11, which presents zeta potential of Embodiments 1-3 and Comparative sample 1 from Table 1. The results indicate that, compared with the Comparative sample 1, the embodiments of the present invention endow the surface with strong negative charges, resulting in better adsorption performance and enhanced attraction to pollutants with positively charges.

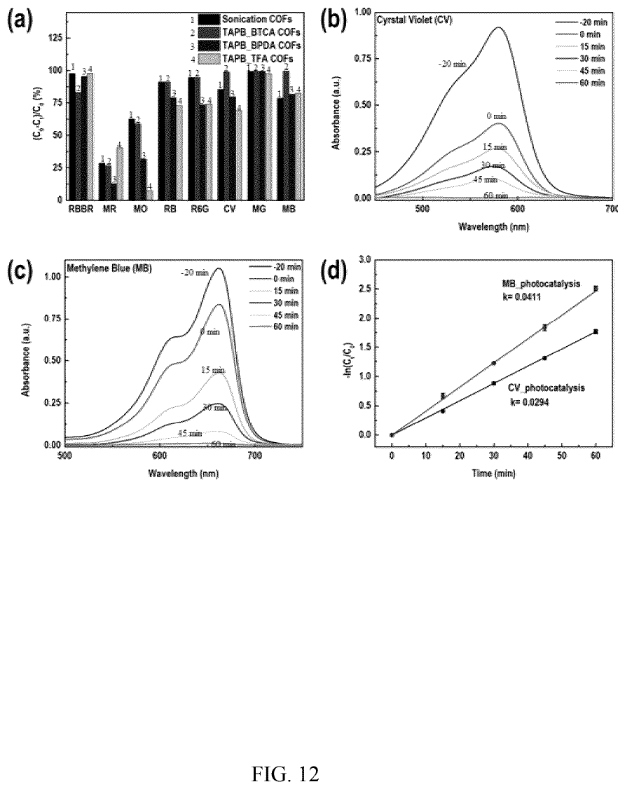

Please refer to FIG. 12, which shows photocatalytic efficiency tests of Embodiments 1-3 and Comparative sample 1 for different organic dyes. In FIG. 12, (a) shows the selectivity experiments for Embodiments 1-3 and Comparative sample 1; (b) displays the UV/Visible spectral monitoring of the photocatalytic degradation of Crystal Violet (CV) using Embodiment 3; (c) displays the UV/Visible spectral monitoring of the photocatalytic degradation of Methylene Blue (MB); and (d) shows the first-order fitting results for the photocatalysis of CV and MB.

The results demonstrate that the characteristic peaks of the dyes decrease over time, indicating that the present invention effectively achieves dye adsorption and degradation.

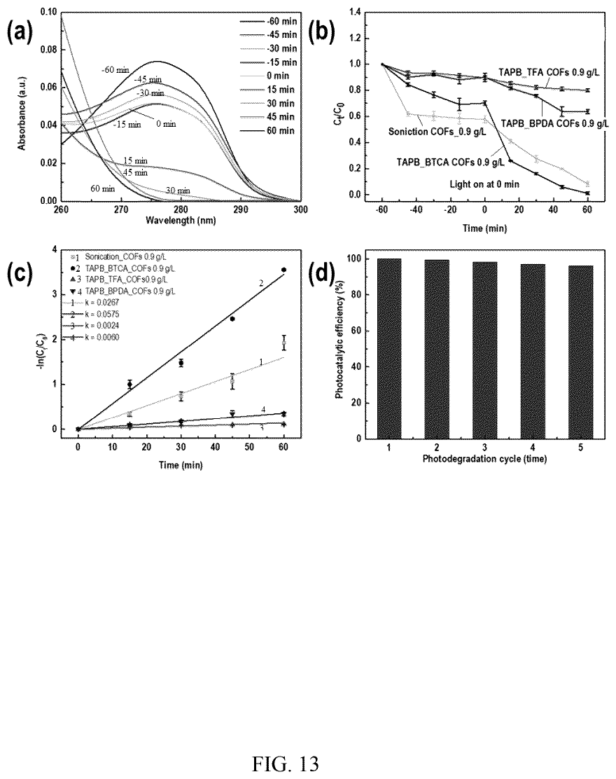

Please refer to FIG. 13, which shows the photodegradation test of bisphenol A (BPA) for Embodiments 1-3 and Comparative sample 1 listed in Table 1. The test method involves adding the embodiments of the present invention and Comparative sample 1 into a solution containing BPA. The solution is stirred in the dark for one hour to reach adsorption equilibrium, followed by simulated sunlight irradiation for one hour. During the test, the absorbance peak of BPA at 276 nm is measured every 15 minutes using UV/Vis spectroscopy, and its concentration is determined using Beer's Law (or also known as Beer-Lambert law).

In FIG. 13, (a) shows the UV/Vis spectra of BPA itself during the photocatalytic experiment; (b) compares the adsorption and photodegradation performance of BPA under simulated sunlight for Comparative sample 1, Embodiment 3 (TAPB_BTCA COF), Embodiment 2 (TAPB_TFA COF), and Embodiment 1 (TAPB_BPDA COF); (c) presents the first-order fitting results for BPA photodegradation for each embodiment and Comparative sample 1; and (d) shows the reusability (recyclability) results of the photocatalytic degradation of BPA for each embodiment.

The results indicate that the embodiments of the present invention achieve a removal/decomposition efficiency of up to 99% for BPA under simulated sunlight irradiation for 1 hour. Furthermore, the recyclability of the catalyst is an essential parameter for heterogeneous catalysis in practical applications. As shown in FIG. 13(d), after five cycles of use, Embodiment 3 (TAPB_BTCA COF) of the present invention still retains its catalytic effectiveness, demonstrating that the porous materials produced by the present invention exhibit highly reusable photocatalytic performance.

Please refer to Table 3, which compares a removal/degradation efficiency of Embodiment 3 of the present invention with conventionally used photocatalysts for bisphenol A (BPA). The results demonstrate that the present invention achieves the best removal/degradation performance than the conventional photocatalysts.

TABLE 3

| | Concentration | bisphenol A | | | |
|---|---|---|---|---|---|
| | of the | (BPA) | | Reaction | Removal |
| | sample | Concentration | | time | rate |
| Samples | (g/L) | (ppm) | Light Source | (min) | (%) |
| Embodiment 3 | 0.9 | 50 | 150 W | 60 | 99 |
| | | | Xenon light | | |
| 0.5 wt % | 0.3 | 1 | 350 W | 180 | 85.7 |
| CdS/COFs | | | Xenon light | | |
| COF-PRD | 0.3 | 10 | Visible light | 150 | 98 |
| CSCF | 0.5 | 3 | 300 W | 180 | 94 |
| | | | Xenon light | | |
| TMT-TT-COF | 0.33 | 25 | 300 W | 60 | 96 |
| | | | Xenon light | | |
| TMT-N-COF | 0.33 | 25 | 300 W | 60 | 94.7 |
| | | | Xenon light | | |
| COF-TD1 | 0.3 | 5 | Xenon Arc | 120 | 97 |
| | | | light | | |
| Co-CTF-1 | 0.5 | 10 | 300 W | 60 | 98.6 |
| | | | Xenon light | | |

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A production method of porous materials comprising the steps of:
Step 1: providing a micro-plasma system comprising:
an anode;
a cathode, and
a reaction solution; wherein the anode is at least partially immersed in the reaction solution, the cathode is a tube with its opening positioned near and above the reaction solution, and a gas is introduced into the tube;
Step 2: applying a current to the micro-plasma system for a duration of 0.5 to 24 hours, thereby forming a porous material in the reaction solution; wherein:
the reaction solution in Step 1 comprises an amine precursor, an aldehyde precursor, and an electrolyte, and the reaction solution does not include any toxic or volatile organic solvents;
the concentration of the amine precursor ranges from 5 to 20 mM and includes 1,3,5-tris(4-aminophenyl)benzene;
the concentration of the aldehyde precursor ranges from 5 to 30 mM and includes one or a combination of benzene-1,3,5-tricarbaldehyde, terephthalaldehyde, and 4,4′-biphenyldicarboxaldehyde; and
the concentration of the electrolyte ranges from 1 to 20 mM and includes acetic acid.

2. The method as claimed in claim 1, wherein: further comprising a purification step after Step 2, wherein the reaction solution containing the porous material is subjected to centrifugation and ultrasonic washing, followed by drying to obtain the purified porous material.

3. The method as claimed in claim 1, wherein the porous material comprises covalent organic frameworks (COFs) and/or metal-organic frameworks (MOFs) having dye or toxin adsorption and/or photocatalytic degradation performance.

4. The method as claimed in claim 2, wherein the porous material comprises covalent organic frameworks (COFs) and/or metal-organic frameworks (MOFs) having dye or toxin adsorption and/or photocatalytic degradation performance.

5. The method as claimed in claim 1, wherein the anode is a platinum electrode, and the cathode is a metal tube with an inner diameter ranging from 100 to 200 μm.

6. The method as claimed in claim 2, wherein the anode is a platinum electrode, and the cathode is a metal tube with an inner diameter ranging from 100 to 200 μm.

7. The method as claimed in claim 1, wherein the gas comprises an inert gas, and the gas flow rate ranges from 10 to 100 sccm.

8. The method as claimed in claim 2, wherein the gas comprises an inert gas, and the gas flow rate ranges from 10 to 100 sccm.

9. The method as claimed in claim 7, wherein the inert gas comprises argon gas.

10. The method as claimed in claim 8, wherein the inert gas comprises argon gas.

11. The method as claimed in claim 1, wherein the current ranges from 0.1 mA to 100 mA.

12. The method as claimed in claim 2, wherein the current ranges from 0.1 mA to 100 mA.

13. The method as claimed in claim 2, wherein the purification step comprises adding the reaction solution containing the porous material into ultrapure water, placing it into a centrifuge tube for centrifugation to remove unreacted solution, adding acetone, washing the powder with an ultrasonic cleaner, and centrifuging again to remove the washing acetone.

14. The method as claimed in claim 13, wherein further comprising adding ethanol to the centrifuge tube, dispersing the porous material powder into an evaporating dish, and drying it in an oven until a dry powdered state is achieved.

15. The method as claimed in claim 3, wherein the dye comprises Crystal Violet or Methylene Blue, and the toxin comprises bisphenol A.

16. The method as claimed in claim 4, wherein the dye comprises Crystal Violet or Methylene Blue, and the toxin comprises bisphenol A.
